(19) United States
(12) Patent Application Publication
(10) Pub. No.: US 2007/0185254 A1
(43) Pub. Date: Aug. 9, 2007

(54) Composition of recycled thermal-plastic damping material

(75) Inventors: Wen-Hsia Chen, Tucheng City (TW); Mark Lin, Taoyuan (TW)

Correspondence Address: TROXELL LAW OFFICE PLLC;SUITE 1404, 5205 LEESBURG PIKE, FALLS CHURCH, VA, 22041, US

(73) Assignee: Yen Ham Bio-Technology Company

(21) Appl. No.: 11/346,332

(22) Filed: Feb. 3, 2006

(51) Int. Cl. C08G 18/08

(52) U.S. Cl. 524/507; 524/502

(57) ABSTRACT

A novel composition of recycled thermal-plastic damping material is disclosed. The damping property of the composition remains good from low-frequency vibrations (1 Hz) to high-frequency vibrations (50 Hz) at general operational temperatures. The composition can further be processed by injection molding machines since it is thermal-plastic.

### CROSS-REFERENCES TO RELATED APPLICATIONS

Not Applicable

### STATEMENT REGARDING FEDERALLY SPONSORED RESEARCH OR DEVELOPMENT

Not Applicable

### DESCRIPTION

1. Field of the Invention

The present invention relates to a novel composition of thermal-plastic damping material that is suitable for general injection molding machines and can be recycled for reprocessing.

2. Background of the Invention

Vibration and noise have been common issues for a long time, but become more important as the requirements for industrial development, process precision, safety, and comfort are emphasized. Noise usually results from vibration, and both of them affect the degree of comfort. Hence, there is a need to prevent human-related things like architectural bases, vehicles, electrical equipment, sports goods, office equipment, and personal information equipment from vibrating.

Conventional buffer material, such as silicon, EPDM or NBR, has poor capability of damping. But rubber with great damping value, such as IIR, must be treated by thermal setting process or thermal cross-linking process, which also produces lots of trimmings and wastes energy. Additionally, the products and trimmings cannot be recycled and processed again.

On the other hand, traditional thermal-plastic rubber possesses low damping value and has no effect on damping. Therefore, the invention provides a composition with characteristics of thermal-plastic and high damping, which can be processed by general injection molding machines and can be recycled as well. The workability and properties of the composition are superior to those of traditional rubber.

### SUMMARY OF THE INVENTION

It is an object of the invention to provide a composition combining the characteristics of thermal-plastic and high damping, of which damping property remains good from low-frequency vibrations (1 Hz) to high-frequency vibrations (50 Hz) at common operational temperatures. Furthermore, the composition can be processed by general injection molding machines and recycled, and has better workability and properties than traditional rubber.

### BRIEF DESCRIPTION OF THE DRAWINGS

The foregoing aspects, as well as many of the attendant advantages and features of this invention will become more apparent by reference to the following detailed description, when taken in conjunction with the accompanying drawings, wherein:

FIG. 1 is the graph of impact test for the composition in accordance with one embodiment of the present invention; and

FIG. 2 is the graph of impact test for conventional silicone rubber.

### DETAILED DESCRIPTION OF SOME EMBODIMENTS

The invention designs the composition of material from the viewpoints of controlling the structure of thermal-plastic polymer, processes the same by compounding and dispersing, and finishes products by injection molding. The resultant product has the property of high damping and can be recycled for further processing.

The aforesaid composition comprises:

(a) polyolefin elastomer: 100 parts;
(b) isobutylene-isoprene rubber (IIR): 10-60 parts;
(c) thermal-plastic polyurethane (TPU): 10-90 parts;
(d) nano-inorganic lamina (size 50-250 nanometers, nm): 5-100 parts; and
(e) white wax: 5-100 parts.

In a preferred embodiment of the invention, 100 parts of (a) polyolefin elastomer, 100 parts of (b) IIR, 50 parts of (c) TPU, 30 parts of (d) nano-inorganic lamina with size of 50-250 nanometers, and 50 parts of (e) white wax are mixed and compounded by the twin-screw extruder at 200° C., and then processed to be standard samples by injection molding.

[Test 1]

The damping value (tan δ) of the composition analyzed by the dynamic mechanical analyzer (DMA) and the comparison with cross-linked silicon rubber are listed in the following Table.

TABLE 1
Comparison of tan δ between the damping material according to
one embodiment of the invention and conventional silicone rubber,
wherein the sample of this embodiment is numbered as YH-156B.

| | Damping material of | |
|---|---|---|
| | one embodiment of the | |
| | invention No.: YH-156B | Silicone Rubber |
| Sample | (Hardness: shore A 60) | (Hardness: shore A 60) |
| The greatest | 0.95(tan δ) | 0.25(tan δ) |
| damping value | | |

[Test 2]

In an embodiment, a rectangular sample of YH-156B with a size of 23 mm×6 mm×4 mm (millimeters) is fabricated by injection molding. The sample is further tested and compared to a sample of cross-linked silicone rubber having the same size as the sample of YH-156B. The test method includes the steps of:
1. adhering the sample of YH-156B or the sample of silicone rubber onto a steel plate;
2. adhering an AG acceleration sensor onto the center at the opposite side of the steel plate;
3. Impacting by means of the impact machine; and

4. measuring G values, wherein the size of the steel plate is 28.0 cm (centimeters)×28.0 cm×5.20 mm (millimeters), the weight of the steel plate is 3016 grams, the test machine number is LAB3636, and the setting values thereof are 150 G/2 ms/filter:1000 Hz.

TABLE 2
Positions of the sample of YH-156B and the sample of silicone rubber
during performing impact test.

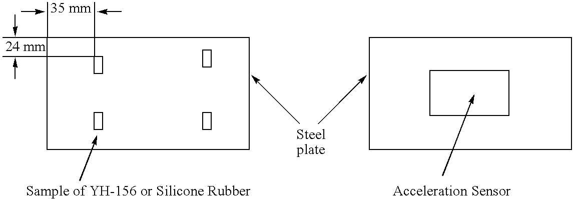

TABLE 3
Comparison of impact results between the damping
material according to one embodiment of the invention
and conventional silicone rubber

| | G's | Improvement % |
|---|---|---|
| Silicone Rubber | 236.22 | |
| YH156B (recycled damping material | 175.17 | 26% |
| with high performance) | | |

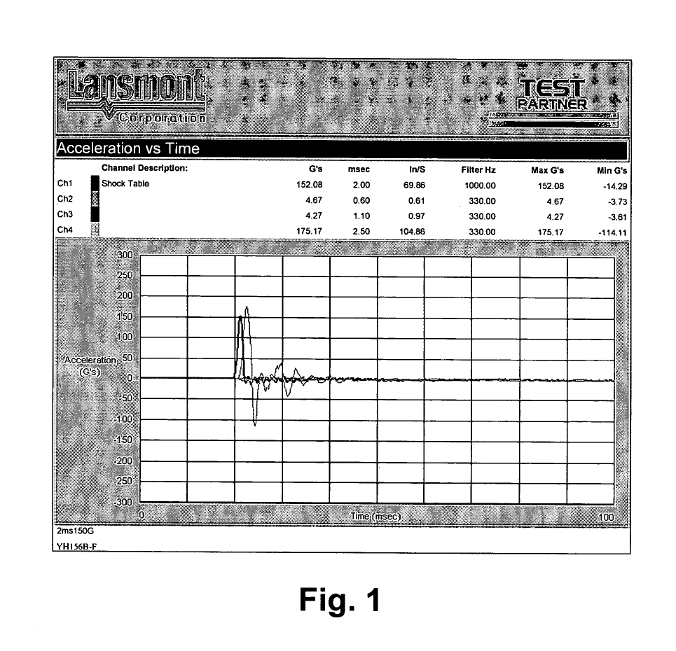

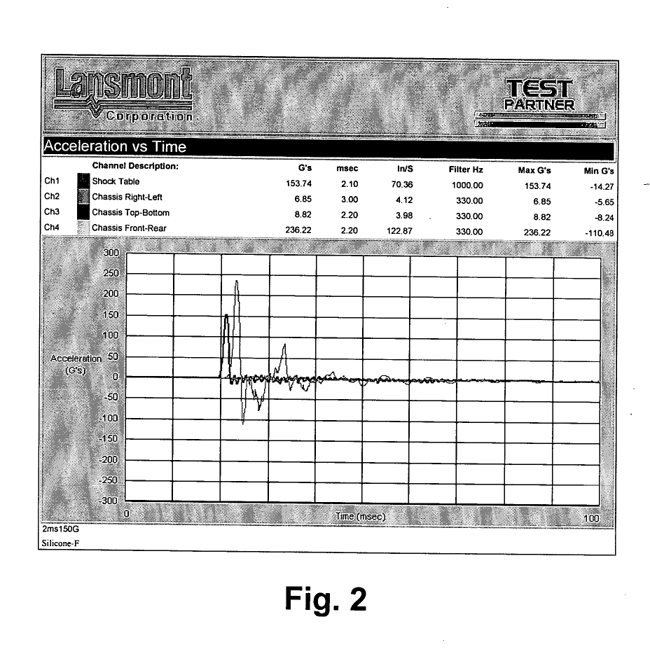

References are made to Table 1, Table 3, FIG. 1 showing the impact curve of the composition according to one embodiment of the invention, and FIG. 2 showing the impact curve of conventional silicone rubber. It is found that the damping property of the composition remains good from low-frequency vibrations (1 Hz) to high-frequency vibrations (50 Hz) at general operational temperatures. Furthermore, the composition can be processed by conventional injection molding machines due to its thermal-plastic characteristics and can be recycled. The workability and properties thereof are superior to traditional rubber that is low damping and can not be recycled.

The ratio of (a) polyolefin elastomer, (b) IIR, (c) TPU, (d) nano-inorganic lamina with size of 50-250 nanometers, and (e) white wax can be varied without changing the property thereof.

The composition of one embodiment of the invention is mixed and compounded by the twin-screw extruder, which is merely an exemplar and is not limited to the scope of the invention.

Moreover, the composition of one embodiment of the invention is mixed and compounded by the twin-screw extruder at 200° C., which is not intended to limit the invention. The operational temperature can be adjusted according to the content of composition.

While the invention has been particularly shown and described with reference to the preferred embodiments thereof, these are, of course, merely examples to help clarify the invention and are not intended to limit the invention. It will be understood by those skilled in the art that various changes, modifications, and alterations in form and details may be made therein without departing from the spirit and scope of the invention, as set forth in the following claims.

What is claimed is:

1. A composition of recycled thermal-plastic damping material, the composition comprises: (a) 100 parts of polyolefin elastomer, (b) 100 parts of isobutylene-isoprene rubber (IIR); (c) 50 parts of thermal-plastic polyurethane (TPU); (d) 30 parts of nano-inorganic lamina with a size of 50-250 nanometers; and (e) 50 parts of white wax, wherein the composition is mixed by a twin-screw extruder at 200° C., and is processed as a standard sample by injection molding.

2. The composition of claim 1, wherein a ratio of (a) polyolefin elastomer, (b) IIR, (c) TPU, (d) nano-inorganic lamina with size of 50-250 nanometers, and (e) white wax is varied without changing properties of the composition.

3. The composition of claim 1, wherein the composition is mixed by an extruder similar to the twin-screw extruder.

4. The composition of claim 1, wherein the composition is mixed at a temperature adjusted according to contents of the composition.
